(19) United States
(12) Patent Application Publication
(10) Pub. No.: US 2020/0335996 A1
(43) Pub. Date: Oct. 22, 2020

(54) DEVICE FOR REGULATION OF A MOTOR VEHICLE ALTERNATOR AND CORRESPONDING ALTERNATOR

(71) Applicant: Valeo Equipements Electriques Moteur, Creteil (FR)

(72) Inventors: Pierre Chassard, Creteil (FR); Pierre Tisserand, Creteil (FR); Pierre-François Ragaine, Creteil (FR)

(73) Assignee: Valeo Equipements Electriques Moteur, Creteil (FR)

(21) Appl. No.: 16/090,042

(22) PCT Filed: Feb. 28, 2017
(86) PCT No.: PCT/FR2017/050438

§ 371 Date: Sep. 28, 2018

(30) Foreign Application Priority Data
Mar. 29, 2016 (FR) 1652681

(51) Int. Cl. H02J 7/00; H02J 7/14; H02P 9/30; H02P 9/08

(52) U.S. Cl. CPC H02J 7/007194; H02J 7/14; H02P 2101/45; H02P 9/08; H02P 9/305

(57) ABSTRACT

The regulating device (5) according to the invention for an excitation alternator (9) comprises a voltage feedback loop (6) and a temperature feedback loop (15) comprising means for measuring/estimating temperature supplying a current temperature (T), a comparator (18) generating a temperature error (εT) between a maximum permissible temperature (Tₘₐₓ) and the current temperature, means for inputting a current speed of rotation of the alternator, a control module (19) supplying a percentage of a maximum permissible excitation (rₘₐₓ) as a function of the temperature error and a speed correction supplied by speed correction means according to a predetermined correction law as a function of the current rotation speed.

### TECHNICAL FIELD OF THE INVENTION

The present invention relates to a device for regulation of a motor vehicle alternator. The invention also relates to the alternator comprising this regulation device.

### TECHNOLOGICAL BACKGROUND OF THE INVENTION

In order to face up to the increase in power which an alternator or alternator-starter of a motor vehicle must provide nowadays because of the increase in the consumption of the on-board equipment, there is a tendency to use nominal on-board network voltages of approximately 48 V instead of 12 V, in order to provide power of approximately 4 to 10 kW.

In addition, even if the nominal voltage of the on-board network continues to be 12 V, it may be desirable in certain cases to boost intermittently the output performance of an alternator by increasing the intensity of an excitation current circulating in a rotor of the alternator.

One way of increasing the output performance of a standard alternator is to decrease the impedance of an excitation winding of the rotor, which has the effect of increasing the excitation current, and therefore the magnetic flux, for the same nominal on-board network voltage.

This manner of proceeding is advantageous in a downsizing operation, i.e. when it is required to use in a vehicle of certain category a piece of equipment whilst boosting its characteristics.

However, in the case of a boosted alternator, the equipment manufacturer clearly has the problem of the thermal balance of the machine, with the increase in the currents increasing correspondingly the losses by Joule effect.

It is therefore necessary to limit the alternator current to a value which depends on the temperature of the alternator.

In patent application FR2938987, the company VALEO EQUIPEMENTS ELECTRIQUES MOTEUR describes a method for limitation of a maximum excitation current in an alternator-starter system for a vehicle. According to this method, the maximum excitation current is determined on the basis of at least one limitation curve of the pre-programmed maximum excitation current, depending on the temperature of the alternator-starter. A speed of rotation of the alternator-starter is also taken into account in order to determine the maximum excitation current.

The method described permits efficient stabilisation of the temperature at a stationary speed, but the inventive body has found that there is degradation of the current output of the machine during phases of transition at speed.

In fact, the return to a thermal balance is a slow phenomenon (thermal time constant with an order of magnitude of 200 s) relative to a speed transition which can be approximately a few seconds, for example. As a result, the maximum excitation current can be unnecessarily limited by the limitation method, whilst the temperature of the machine tends to stabilise.

### GENERAL DESCRIPTION OF THE INVENTION

The objective of the present invention is thus to modify the behaviour of a thermal limitation function, in order to avoid this loss of output, in particular during phases of deceleration and acceleration of the vehicle.

The invention relates to a device for regulation of a motor vehicle alternator which subjects a direct voltage generated by this alternator to a predetermined set voltage.

This direct voltage is controlled by controlling a current which circulates in an excitation circuit comprising an excitation winding of a rotor of the alternator.

This regulation device is in itself known, and also maintains an actual temperature of the alternator below a predetermined maximum permissible temperature.

According to the invention, the device for regulation of a motor vehicle alternator comprises a control loop comprising:
means for acquisition of the direct voltage generated and supplying a measured voltage;
a first comparator of this measured voltage of the set voltage generating a voltage error;
first means for conditioning of this voltage error providing an input excitation percentage;
a saturation module providing, according to this input excitation percentage, an output excitation percentage which is limited to a maximum permissible excitation percentage;
a generator of a pulse width modulated signal with a duty cycle equal to the output excitation percentage;
a semiconductor switch controlled by the pulse width modulated signal controlling the intensity of the excitation current.

The regulation device according to the invention also comprises a temperature control loop comprising:
a first means for measurement/estimation of temperature providing the actual temperature of the alternator;
a second comparator generating a temperature error between the maximum permissible temperature and the actual temperature;
means for inputting an actual speed of rotation of the alternator;
a control module providing the maximum permissible excitation percentage according to the temperature error and a speed correction provided by means for correction of speed according to a predetermined correction law which depends on the actual speed of rotation.

According to the invention, the temperature control loop additionally comprises a means for taking into account an ambient temperature, and the correction law is parameterised by the ambient temperature.

Also according to the invention, the correction law has a so-called dish form and:
has at least one first negative slope between a first speed of rotation which depends on the ambient temperature and a second predetermined speed of rotation;
is zero between the second speed of rotation and a third predetermined speed of rotation;
has at least one second, positive slope between the third speed of rotation and a fourth speed of rotation, which varies according to the said ambient temperature.

In the device for regulation of a motor vehicle alternator according to the invention, the control module also comprises:
second means for conditioning of the temperature error providing a thermal correction percentage;
a comparator-adder calculating the maximum permissible excitation percentage by subtracting the thermal correction percentage from a first sum of a maximum reference excitation percentage and of the speed correction.

Also according to the invention, the control module additionally comprises means for forcing the maximum permissible excitation percentage to the maximum reference excitation percentage.

These forcing means are activated according to the invention by an activation order of an engine control unit of the vehicle.

According to the invention, the forcing means are activated if, and only if, a temporal variation (dV/dt) of the actual speed of rotation is greater as an absolute value than a predetermined threshold.

According to the invention, the forcing means remain active for as long as the actual temperature is lower than a limit temperature equal to the maximum permissible temperature augmented by a predetermined temperature increase.

According to the invention, the forcing means are deactivated by a timer for a predetermined duration when the actual temperature reaches the limit temperature.

The subject of the invention is also a motor vehicle alternator comprising a regulation device as previously described.

These few essential specifications will have made apparent to persons skilled in the art the advantages provided by the invention in comparison with the prior art.

The detailed specifications of the invention are given in the description which follows in association with the appended drawings. It should be noted that these drawings serve the purpose simply of illustrating the text of the description, and do not constitute in any way a limitation of the scope of the invention.

### BRIEF DESCRIPTION OF THE DRAWINGS

FIGS. 1a and 1b show readings of outputs and temperatures according to a speed of rotation of alternators known in the prior art with a thermal balance which is non-critical and critical, respectively.

FIG. 2 is a general process diagram of a device for regulation of a motor vehicle alternator, comprising a temperature control loop according to the invention.

FIGS. 3a and 3b are respectively a graph representing a control law defining a maximum permissible excitation percentage and another graph representing a saturation function derived from this control law.

FIG. 4a establishes a comparison between the readings of outputs and temperatures of a standard alternator (thin lines) and a similar alternator provided with a regulation device according to the invention (thick lines) in a hypothesis where speed correction according to the invention is not applied, and FIGS. 4b and 4c show respectively the maximum permissible excitation percentage for one and the other of these alternators.

FIGS. 5a, 5b, 5c and 5d show respectively time diagrams of a transition of a speed of rotation of an alternator provided with a regulation device according to the invention, of an excitation current, of an actual temperature, and of the output of the alternator in the hypothesis where the speed correction according to the invention is not applied.

FIG. 6 establishes a comparison between the readings of outputs during a speed transition when the temperature control loop according to the invention is deactivated before the speed transition (broken line) and when it is active (solid line), in the hypothesis where the speed correction according to the invention is not applied.

FIG. 7 illustrates effects on the maximum permissible excitation percentage of a law of speed correction intervening in the temperature control loop of the device for regulation of a motor vehicle alternator according to the invention.

FIG. 8 is a detailed process diagram of the temperature control loop of the device for regulation of a motor vehicle alternator according to a first preferred embodiment of the invention.

FIGS. 9a, 9b, 9c, 9d, 9e and 9f show respectively time diagrams of the speed transition of the alternator provided with a regulation device according to the first preferred embodiment of the invention, of the actual temperature, of a thermal correction percentage, of the speed correction, of a maximum permissible excitation percentage, and of the output of the alternator.

FIG. 10 establishes a comparison between the readings of outputs during a speed transition where the speed correction of the temperature control loop according to the first preferred embodiment of the invention shown in FIG. 8 intervenes (solid line), and if the speed correction according to the invention was not applied (broken line).

FIG. 11 is a detailed process diagram of the temperature control loop of the device for regulation of a motor vehicle alternator according to a second preferred embodiment of the invention.

FIG. 12 establishes a comparison between the readings of outputs during a speed transition where the speed correction of the temperature control loop according to the first preferred embodiment of the invention shown in FIG. 8 intervenes (solid line) and where an action of the temperature control loop is temporarily suspended according to the second preferred embodiment of the invention shown in FIG. 11 (broken line).

FIG. 13 is an example of a time diagram of the maximum permissible excitation percentage (solid line) for a specific embodiment of an alternator provided with the regulation device according to the invention (asymptotic curve in a broken line).

FIG. 14 illustrates static behaviour of an alternator according to the invention with the output curves (hollow lines) and temperature curves (solid lines) with (continuous lines) and without (dot and dash lines) limitation.

### DESCRIPTION OF THE PREFERRED EMBODIMENTS OF THE INVENTION

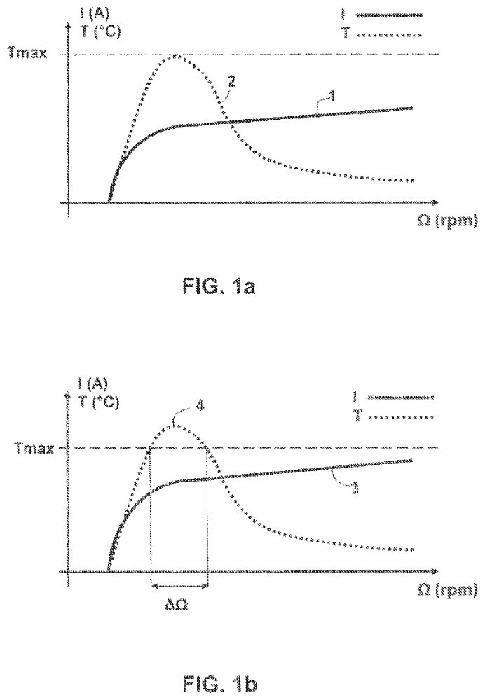

The thermal problem of an alternator in general is illustrated in FIGS. 1a and 1b.

The curve in a solid line 1 in FIG. 1a represents the characteristic of an output I of an alternator according to its speed of rotation Ω for maximum (so-called “full field”) excitation at a maximum ambient temperature (for example 125° C.) and at an operating voltage imposed (for example 13.5 V).

The “iron” alternator temperature T, i.e. at a point of the magnetic mass of the stator, can then be read for different speeds of rotation Ω of the rotor at so-called “stabilised” points; the resulting curve is also shown in a broken line 2 in FIG. 1a.

An alternator which has good thermal balance has an “iron” temperature T which does not exceed the maximum permissible “iron” temperature threshold Tₘₐₓ. This thermal balance is then non-critical for the aforementioned operating conditions.

In the case of a machine where the output performance I is increased (boosted alternator) as shown by the other curve in a solid line 3 in FIG. 1b, by decreasing the impedance of an excitation winding of the rotor for example, which has the effect of increasing an excitation current, the “iron” temperature T exceeds the maximum permissible temperature threshold Tₘₐₓ in the aforementioned operating conditions in a so-called “temperature critical” speed interval ΔΩ, as also shown by the other curve in a broken line 4. An event of this type of exceeding of the maximum temperature threshold can also occur when the alternator is operating with a temperature under the bonnet which is higher than normal.

In these conditions, the means for cooling the alternator cannot discharge the heat due to the different losses by Joule effect (iron losses, copper losses, etc.).

The thermal balance of the machine is then considered to be broken. An excessively long duration of operation of the alternator in the temperature-critical speed interval ΔΩ is liable to give rise to destruction of the machine as the result of an excessive temperature.

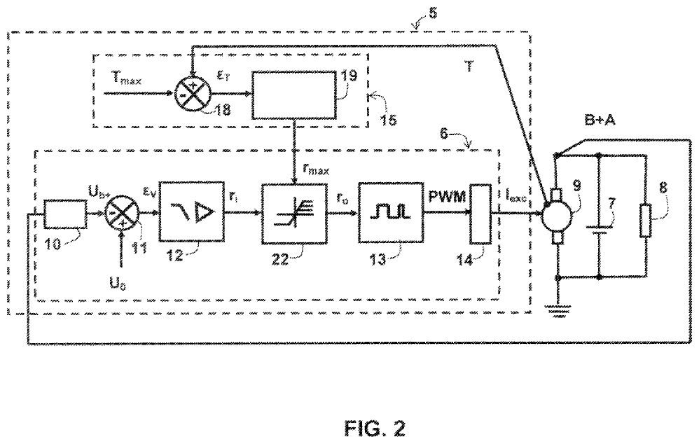

The device 5 for regulation of an alternator according to the invention, the general process diagram of which is given in FIG. 2, is associated substantially with the problem of the thermal stability of a boosted alternator.

In order to solve the thermal problem of the alternator, a solution proposed by the inventive body is the use of the regulator 5 in order to control an actual temperature T of the alternator by means of a sensor placed on the alternator (more specifically for example on the iron of a stator or on a rear bearing of the machine, in order to measure temperatures of the diodes).

In a manner which in itself is known, this regulator 5 comprises a voltage control loop 6 which makes it possible to subject to a set voltage U₀ a direct voltage B+A of an on-board network of the vehicle, in general comprising a battery 7 and various items of equipment 8 supplied by the alternator 9.

Conventionally, this voltage control loop 6 comprises:
means 10 for acquisition of the direct voltage B+A taken on a positive terminal of the alternator 9 supplying a measured voltage U_{b+};
a first comparator 11 of the measured voltage U_{b+} of the set voltage U₀ generating a voltage error εᵥ;
first means 12 for conditioning of this voltage error εᵥ by filtering and adaptation of gain providing an input excitation percentage rᵢ;
a generator 13 of a pulse width modulated signal PWM with a duty cycle r₀ equal to an output excitation percentage which depends on the voltage error εᵥ, and controls a semiconductor switch 14 controlling the intensity of excitation I_{exc}.

According to the invention, the regulator 5 additionally comprises a temperature control loop 15.

As shown clearly by FIG. 2, this temperature control loop 15 comprises a first temperature sensor which provides the actual temperature T of the alternator 9.

This can be a sensor outside the regulator 5, placed on the iron of the stator or on the rear bearing, in order to measure the temperature of the diodes, or alternatively a sensor inside the regulator 5, measuring a junction temperature of the semiconductor switch 14.

A second comparator 18 of a predetermined maximum permissible temperature Tₘₐₓ of the actual temperature T generates a temperature error ε_{T} on the basis of which a control module 19 provides the voltage control loop 6 with a maximum permissible excitation percentage rₘₐₓ which makes it possible to maintain the actual temperature T of the alternator 9 at the value of the predetermined maximum permissible temperature Tₘₐₓ.

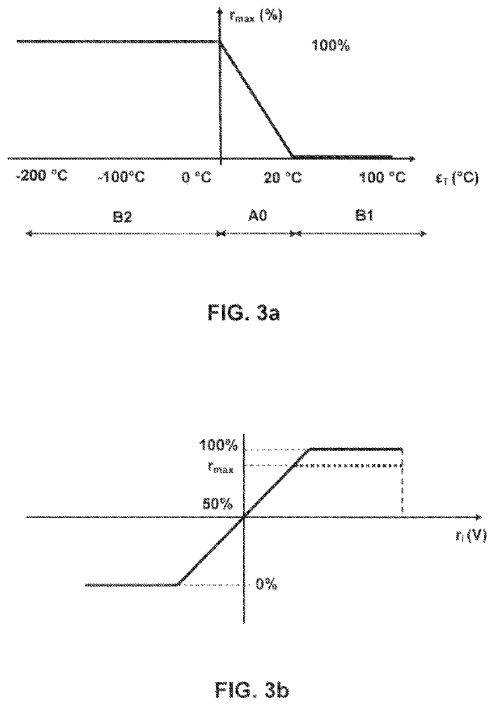

An example of the control law defining the maximum permissible excitation percentage rₘₐₓ according to the temperature error ε_{T} is represented in FIG. 3a.

In this example, in a linear area A0, a slope of the maximum permissible excitation percentage rₘₐₓ according to the temperature error ε_{T} is approximately −5%/° C., in the knowledge that this slope will depend on the gains applied in the regulation processing chain.

In the linear area A0, the slope can be adapted in order to obtain a temperature regulation loop gain which is more or less large according to a required limited temperature precision.

In another area B1 of the control law, where the temperature error ε_{T} is between 20° C. and 100° C., the alternator 9 is at an actual temperature T which is very much higher than the predetermined maximum permissible temperature Tₘₐₓ, and the excitation is cut off (maximum permissible excitation percentage rₘₐₓ of zero).

If the temperature error ε_{T} is negative (area B2 of the control law), the actual temperature T is very much lower than the predetermined maximum permissible temperature Tₘₐₓ, and the excitation depends only on the voltage control loop 6 (maximum permissible excitation percentage rₘₐₓ of 100%).

The maximum permissible excitation percentage rₘₐₓ provided by the control module 19, 20, 21 is applied to a saturation module 22 inserted in series in the voltage control loop 6, between the first means 12 for conditioning of the voltage error εᵥ and the generator of the pulse width modulated signal 13.

The resulting saturation function is represented in FIG. 3b. The output excitation percentage rₒ which depends on the input excitation percentage rᵢ is at the most equal to the maximum permissible excitation percentage rₘₐₓ provided by the control module 19, 20, 21.

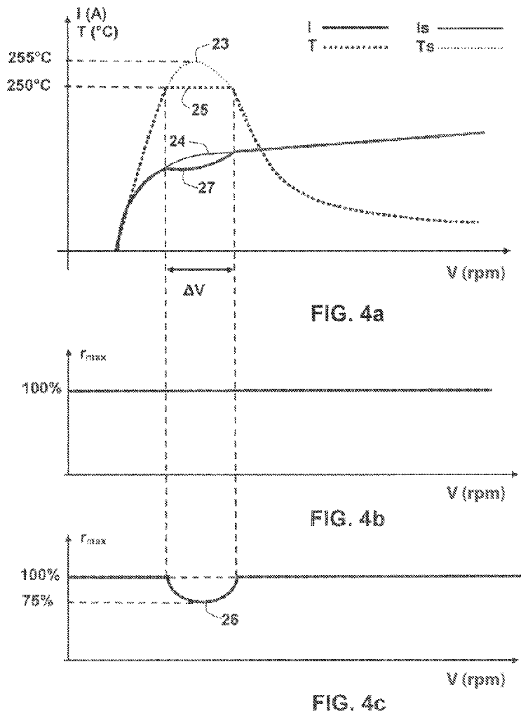

FIGS. 4a, 4b and 4c show the effect of the temperature control loop 15, 16, 17 for an alternator 9 provided with the regulation device 5 according to the invention, in comparison with a standard alternator with a critical thermal balance in a critical speed range ΔV without the regulation device 5 according to the invention, in the case where the actual temperature T is stabilised in a quasi-stationary operating mode, or in a hypothesis where account is not taken of an actual rotation speed V.

For the standard alternator, the actual temperature Ts (thin broken line 23) exceeds 250° C., and reaches 255° C. in the critical speed range ΔV when the output Is (thin solid line 24) increases according to the speed of rotation V, as shown clearly in FIG. 4a, when the excitation continues to be “full field” (FIG. 4b).

For the alternator 9 according to the invention, the actual temperature T (thick broken line 25) remains lower than 250° C.

As a result of the temperature control alone, the excitation 26 does not remain “full field” in the critical speed range ΔV, but decreases by 25% in this example. In these conditions, the output I (thick solid line 27) of the alternator according to the invention is lower than the output Is of the standard alternator, but the maintenance of the alternator 9 below 250° C. already makes it possible to preserve the integrity of its components.

The regulation device 5 according to the invention makes it possible to avoid this loss of output I by taking into account the actual speed of rotation V of the alternator 9 in the temperature control loop 15, 16, 17 at dynamic operating speed.

For the reasons previously indicated, it is at approximately 3000 rpm that the machine 9 reaches its highest actual temperature T. This means that, if the machine 9 is stabilised at 3000 rpm, and the actual speed of rotation V decreases or increases, its actual temperature T will decrease. However, this is a slow phenomenon (thermal time constant of approximately 200 seconds) compared with a speed transition which can be approximately two seconds for example.

If the temperature control loop 15, 16, 17 did not take into account the actual rotation speed V, this would give rise to degradation of the current output I of the machine 9 during these speed transition phases.

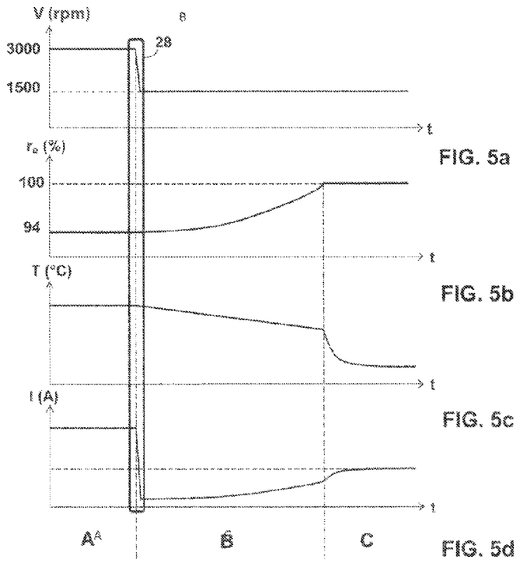

FIGS. 5a, 5b, 5c and 5d are examples which describe this phenomenon before (at A) the speed transition 28, after (at B) the speed transition 28, and after the return to the thermal balance (at C):

A: The actual speed of rotation V of the machine 9 is stabilised at 3000 rpm (FIG. 5a). The temperature control loop 15, 16, 17 has set the output excitation percentage rₒ to 94% (FIG. 5b) in order to limit the output I (FIG. 5d), and thus control the actual temperature T (FIG. 5c).

During a speed transition 28, the actual speed of rotation V develops very quickly from 3000 rpm to 1500 rpm. The actual temperature T has virtually not yet changed, and limitation of the excitation of the rotor is therefore still active at 94% throughout the speed transition 28.

B: The actual temperature T of the machine 9 tends to decrease (FIG. 5c); consequently, the temperature control loop 15, 16, 17 gradually permits greater excitation of the rotor (FIG. 5b), and therefore the output I of the machine 9 increases (FIG. 5d).

C: The excitation of the rotor has returned to 100% (FIG. 5b), and the output I increases slightly further (FIG. 5d) as far as the thermal balance (FIG. 5c) of the machine 9.

At 1500 rpm there would finally be no need to limit the machine 9, however, during and for some time after the speed transition 28, the slow development of the actual temperature T gives rise to a limitation of the output I. A certain time will be necessary in order for the actual temperature T to begin to decrease and stabilise, and for the output I of the alternator 9 to regain a nominal value.

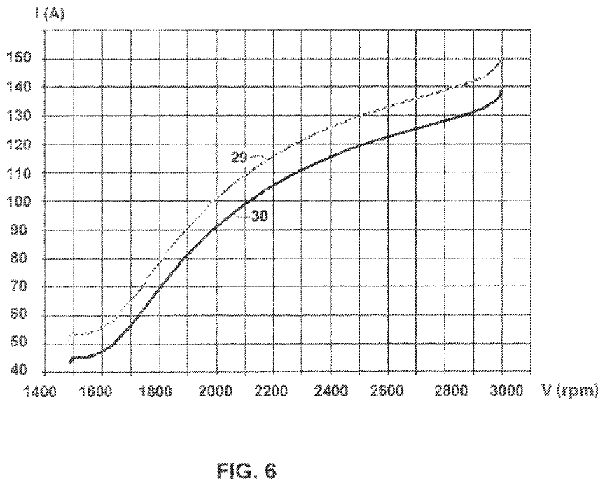

With reference more specifically to the phenomena which occur during the speed transition 28, FIG. 6 represents the output I according to the actual speed of rotation V during this speed transition 28.

FIG. 6 establishes a comparison between the readings of outputs during the speed transition 28 when the temperature control loop 15, 16, 17 according to the invention is deactivated before the speed transition 28 (broken line 29) and when it is active (solid line 30), in the hypothesis where the speed correction according to the invention is not applied.

A loss of output I of approximately 10 A is noted during the speed transition 28; this figure is variable according to the machines 9 and the test conditions, but the behaviour is identical irrespective of the test configuration.

The behaviour during phases of deceleration and acceleration of the vehicle is improved according to the invention by use of the actual speed of rotation V of the alternator 9 as a complement to the actual temperature T of the machine 9 in the temperature control loop 15, 16, 17. This is in order to anticipate the thermal state of the machine 9, and to restore the output I as rapidly as possible.

The principle of the invention is to identify in advance the general form of a speed correction law for a given model of a family of alternators, then to store this general form in the regulation device 5.

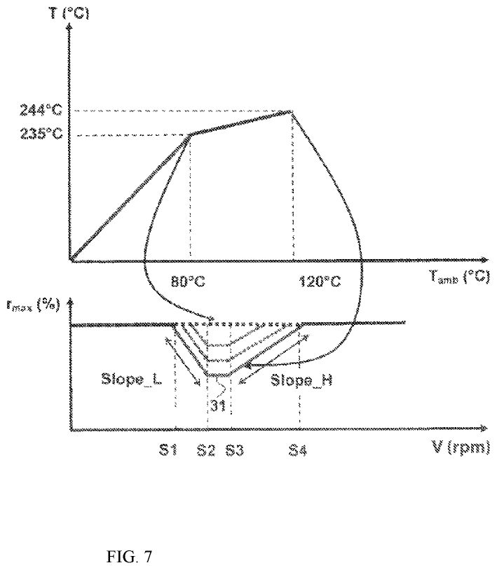

By measuring the maximum permissible excitation percentage rₘₐₓ, i.e. the limitation of the excitation of the rotor whilst the machine 9 is being controlled, it is found that the curves obtained have a so-called “dish” form, which curves can then be approximated as represented in FIG. 7:
with a low actual speed of rotation V, no limitation of the excitation rₘₐₓ is necessary, since the machine 9 is not rotating fast enough to output current, and is therefore not heating up;
starting from a first speed of rotation S1, the limitation of the excitation rₘₐₓ becomes active since the machine 9 is outputting more current. It heats up, but the ventilation is not efficient enough to cool it. The limitation of the excitation rₘₐₓ is increasingly great as the actual speed of rotation V increases;
between a second predetermined speed of rotation S2 and a third predetermined speed of rotation S3 situated below and above 3000 rpm, the machine 9 is working in its critical thermal area, and therefore the limitation of the excitation rₘₐₓ has reached its maximum value;
after this third speed of rotation S3, the limitation of the excitation rₘₐₓ relaxes progressively, since the ventilation becomes increasingly efficient;
when a fourth speed of rotation S4 has been reached, there is no further need to limit the excitation of the machine 9.

According to an ambient temperature T_{amb}, the amplitude of this limitation of the excitation varies. Second and third speeds of rotation S2, S3, forming a maximum limitation plateau 31, are considered constant by approximation, irrespective of the ambient conditions.

Slopes of limitation of the excitation rₘₐₓ /actual speed of rotation V, indicated as Slope_L between the first and second speeds of rotation S1, S2, and as Slope_H between the third and fourth speeds of rotation S3, S4, are also considered constant by approximation. Only the first and fourth speeds of rotation S1, S4 are variable, and depend on an amplitude of the limitation, i.e. on the ambient temperature T_{amb}.

It is the use of these slopes of limitation/speed, Slope_L and Slope_H, which make it possible to anticipate the limitation of excitation and to restore the output I during the speed transition phases 28. Each ambient temperature value T_{amb} corresponds to a correction value providing a correction V_{cor} according to the speed.

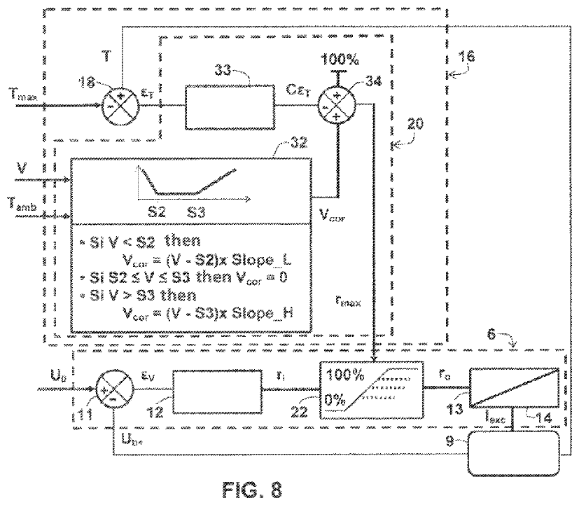

According to a first preferred embodiment of the invention shown in FIG. 8, the temperature control loop 16 comprises a control module 20 comprising speed correction means 32 in which the laws of correction shown in FIG. 7 are stored.

This control module 20 generates the speed correction V_{cor} on the basis of the actual speed of rotation V provided by the input means and the ambient temperature T_{amb}.

The control module 20 additionally comprises:
second means 33 for conditioning of the temperature error E_{T} providing a thermal correction percentage Cε_{T};
a comparator-adder 34 which calculates the maximum permissible excitation percentage rₘₐₓ by subtracting the thermal correction percentage Cε_{T} from a first sum of a maximum reference excitation percentage of 100% and of the speed correction V_{cor}.

The maximum permissible excitation percentage rₘₐₓ is thus given by the equation:

rₘₐₓ=100%−Cε_{T}+V_{cor}.

Three situations are possible:
The actual speed of rotation V is lower than the second speed of rotation S2, then:

V_{cor}=(V−S2)×Slope_L

The lower the actual speed of rotation V, the greater the speed correction V_{cor}. The impact of the temperature is counterbalanced. At a low actual speed of rotation V, the machine 9 heats up little, and the limitation of excitation is thus reduced during a decreasing speed transition 28.
The actual speed of rotation V is between the second speed of rotation S2 and the third speed of rotation S3:
V_{cor}=0

A level of the maximum limitation plateau 31 is affected only by the actual temperature T of the alternator 9.
The actual speed of rotation V is greater than the third speed of rotation S3, then:

V_{cor}=(V−S3)×Slope_H

The greater the speed of rotation V, the greater the speed correction V_{cor}. The impact of the temperature is counterbalanced. At a high speed of rotation V, with the ventilation being sufficiently efficient, the limitation of excitation is thus reduced during a transition 28 to increasing speed.

The maximum permissible excitation percentage rₘₐₓ thus corrected according to the speed of rotation (and implicitly according to the ambient temperature T_{amb}) is transmitted to the saturation module 22 of the voltage control loop 6.

Let it be accepted by way of example that this voltage control loop 6 requires an input excitation duty cycle rᵢ of 96% in order to maintain the required set voltage U₀. For its part, the temperature control loop 16 transmits to the saturation module 22, which in view of the present temperatures and speed of rotation V of the machine 9 of 94%, is at the maximum applicable level.

The saturation module 22 will thus ignore the 96% required by the voltage regulation 6, and will apply the 94% calculated by the temperature limitation 16. The direct consequence will be a measured voltage U_{b+} which is lower than the set voltage U₀, but with a controlled actual temperature T which will not exceed the limit temperature Tₘₐₓ.

Below the first speed of rotation S1 and above the fourth speed of rotation S4, the speed correction V_{cor} is greater than the thermal correction percentage Cε_{T}. This has the consequence that there is simply no more limitation of excitation, and the maximum permissible excitation percentage rₘₐₓ is 100%.

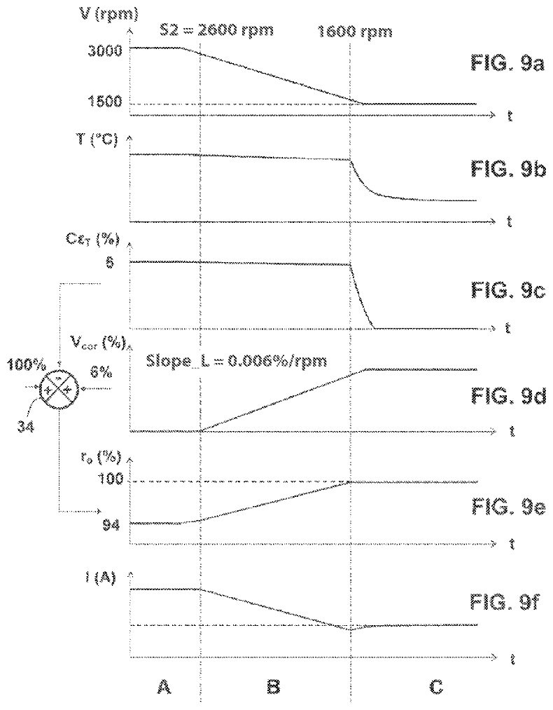

FIGS. 9a, 9b, 9c, 9d, 9e and 9f show clearly the impact of taking into account the speed of rotation V (FIG. 9a) on the output I (FIG. 9f) in comparison with FIGS. 5a, 5b, 5c and 5d, before (at A), during (at B) and after (at C) a decrease in the actual speed of rotation V.

A: The alternator 9 is stabilised at 3000 rpm, i.e. on the maximum limitation plateau 31 between the second speed of rotation S2 (approximately 2600 rpm) and the third speed of rotation S3 (approximately 3600 rpm). The speed correction V_{cor} is then zero, and only the actual temperature T of the machine 9 is taken into account.

The actual speed of rotation V starts to decrease (FIG. 9a).

B: As soon as the actual speed of rotation V is lower than the second speed of rotation S2 (towards 2600 rpm), the speed correction V_{cor} becomes non-zero, with the first slope Slope_L as the parameter (FIG. 9d). The maximum permissible excitation percentage rₘₐₓ applied (FIG. 9e) depends on the temperature error ε_{T} and the speed correction V_{cor}.

It is here that the phenomenon of anticipation intervenes: the slowness of development of the temperature is compensated for by the analysis of the speed.

C: Starting from a certain actual speed of rotation V, the algebraic sum of the maximum reference excitation percentage of 100%, of the thermal correction percentage Cε_{T} (FIG. 9c) and of the speed correction V_{cor} carried out by the comparator-adder 34 is at least 100%; the excitation is thus no longer limited, and the temperature of the machine 9 is stabilised (FIG. 9f).

It will be noted that this behaviour described for deceleration starting from 3000 rpm also corresponds by symmetry to that for acceleration with the third speed of rotation S3 and the second slope Slope_H as other parameters.

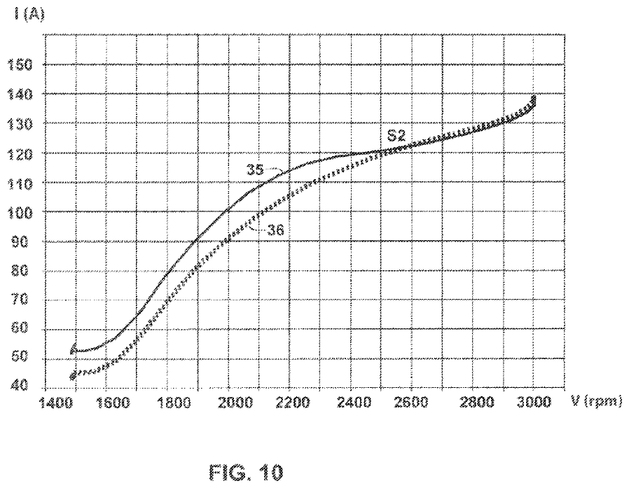

From the point of view of the output I of the machine 9 according to the actual speed of rotation V, the curve shown in FIG. 10 (in a solid line 35) is obtained for a speed transition from 3000 rpm to 1500 rpm in two seconds.

In comparison with the other curve (in a broken line 36) corresponding to the case when the speed correction V_{cor} according to the invention would not be applied, the impact on the output I of the machine 9 during the transitory phase can clearly be observed, when the speed drops once more to below the second speed of rotation S2, to 2600 rpm: the output I is improved.

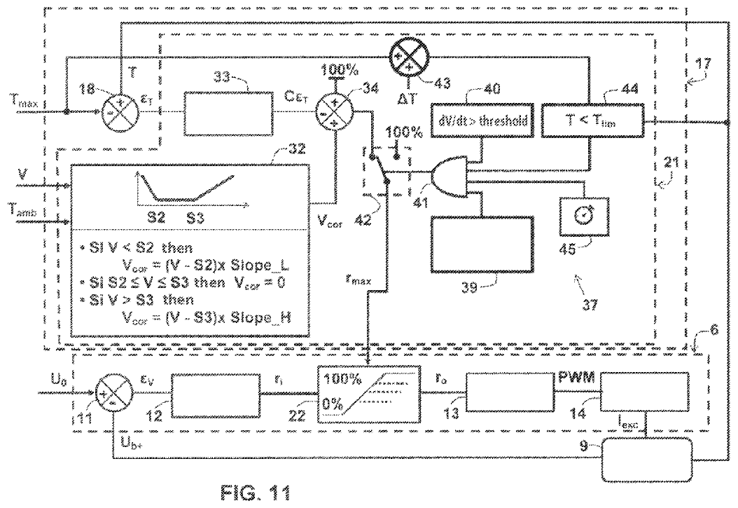

According to a second preferred embodiment of the invention shown in FIG. 11, the temperature control loop 17 comprises a control module 19, 21 comprising, in addition to the means for correction of speed 32 in which the correction laws shown in FIG. 7 are stored, means 37 for forcing the maximum permissible excitation percentage rₘₐₓ to the maximum reference excitation percentage of 100%.

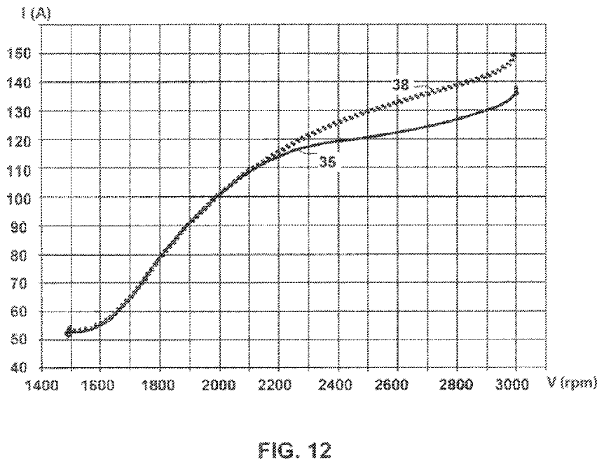

This second embodiment incorporates taking into account the speed information previously described, and, in addition, it temporarily permits an increase in the limitation of excitation during the speed transition phases 28. This is for the purpose of recuperating very quickly a maximum output I of the machine 9, as shown in FIG. 12 (broken line 38), in comparison with the output curve I obtained with the first embodiment of the invention (solid line 35).

As a result, an additional stress is permitted on a critical temperature of the machine 9, for example a temperature of the stator. This stress is taken into account during the design of the machine 9. A provisional increase in temperature, indicated as ΔT, of the maximum permissible temperature Tₘₐₓ, is permitted as far as a limit temperature Tₗᵢₘ.

Authorisation for deactivation of the limitation of excitation, i.e. forcing of the maximum permissible excitation percentage rₘₐₓ to the maximum reference excitation percentage of 100%, is carried out as follows:
an engine control unit 39 provides the forcing means 37 with an activation order;
if, and only if, a temporal variation dV/dt of the actual speed of rotation V greater as an absolute value than a predetermined threshold is observed by a bypass module 40, then the activation order applied to means for validation 41 controlling an inverter 42 between the maximum permissible excitation percentage rₘₐₓ and the maximum reference excitation percentage of 100%, is validated;
for as long as the actual temperature T is lower than the limit temperature Tₗᵢₘ calculated by an adder 43, a detection module 44 maintains validation of the activation order by the means for validation; otherwise, the inverter 42 immediately re-establishes the limitation of excitation to the maximum permissible excitation percentage rₘₐₓ, and a timer 45 is triggered.

Until a predetermined period expires, no new forcing to 100% of the maximum permissible excitation percentage rₘₐₓ can take place.

The example described hereinafter, which is a simple embodiment, with reference in particular to FIGS. 9, 13 and 14, illustrates the impact of the actual speed of rotation V on a thermal limitation calculation during a speed transition 28.

It is wished to integrate the regulation device 5 according to the first embodiment of the invention shown in FIG. 8 in the alternator model produced by the inventive body.

In a first stage, the different parameters are identified. A thermal limit is set at a maximum of 240° C. on a temperature of the stator.

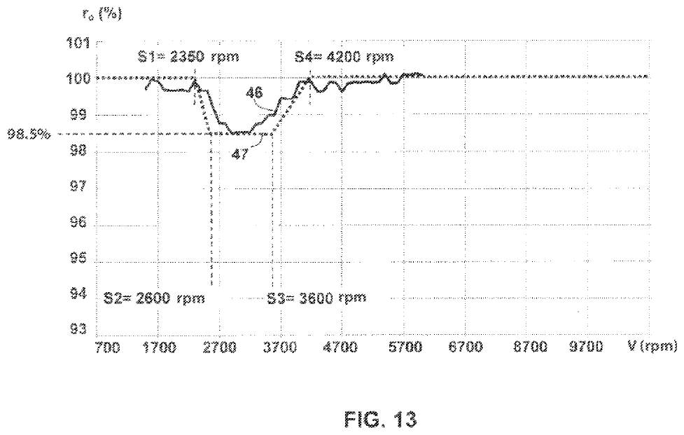

The curve in a solid line 46 in FIG. 13 corresponds to the maximum permissible excitation percentage rₘₐₓ applied according to the actual speed of rotation V, in order not to exceed the 240° C. on the stator. The curve in a broken line 47 is an asymptotic track of this same limitation of excitation.

From the so-called “tub-form” asymptotic curve 47 there are extracted the values of the first and second slopes, Slope_L, Slope_H, and of the second and third speeds S2, S3:
S2=2600 rpm
S3=3600 rpm
Slope_L=(98.5%−100%)/(2600 rpm−2350 rpm)=−0.006%/rpm
Slope_H=(100%−98.5%)/(4200 rpm−3600 rpm)=0.0025%/rpm

Now that the values of the different parameters are known, the temporal behaviour is analysed during a speed transition, with reference to FIG. 9:

A: The actual speed of rotation V is equal to 3000 rpm.

S2=V=S3 therefore applies, and this situation means that V_{cor}=0. Thus, taking into consideration the fact that on the basis of the actual temperature T of the machine 9 limitation of 6% is required, the following applies:

rₘₐₓ=100%−Cε_{T}+V_{cor}=100%−6%+0%=94%

The actual speed of rotation V starts to decrease.

B: The actual speed of rotation V is lower than the second speed of rotation S2.

The transition is rapid, and the actual temperature T measured of the machine 9 remains identical, therefore Cε_{T}=6%.

Let us take some speed points in order to illustrate the calculations:
V=2400 rpm

rₘₐₓ=100%−Cε_{T}+V_{cor}=100%−Cε_{T}+(V−S2)×Slope_L

rₘₐₓ=100%−6%+(2600−2400)rpm×0.006%/rpm
rₘₐₓ=95.2%
V=2000 rpm

rₘₐₓ=100%−6%+(2600−2000)rpm×0.006%/rpm
rₘₐₓ=97.6%
V=1600 rpm

rₘₐₓ=100%−6%+(2600−1600)rpm×0.006%/rpm
rₘₐₓ=100%

The speed correction V_{cor} compensates completely for the limitation of excitation required by the actual temperature T of the machine. The maximum permissible excitation percentage rₘₐₓ is 100%.

C: The actual speed of rotation V is lower than 1600 rpm.
V=1500 rpm

rₘₐₓ=100%−6%+(2600−1500)rpm×0.006%/rpm
rₘₐₓ=100.6% limited to 100%, since the regulation device 5 can clearly not apply more than 100% excitation.

It will be appreciated that, apart from the situation of speed transition, the thermal limitation of the machine 9 is ensured.

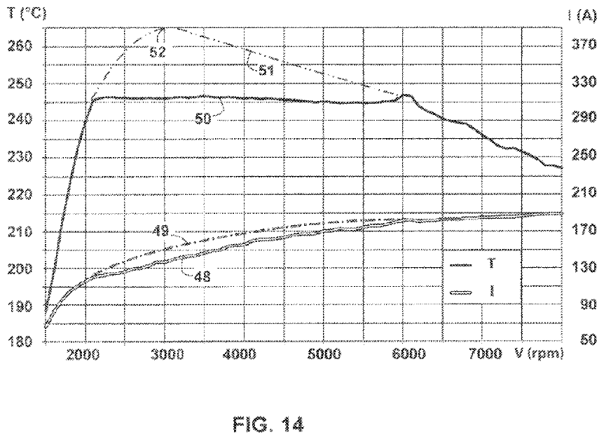

FIG. 14 shows the temperature/output performance of the machine 9 according to the points with stabilised speed, with the output curves I (hollow lines 48, 49) and actual temperature T curves (solid lines 50, 51).

The actual temperature T (solid line 50) of the machine 9 according to the invention is controlled by the decrease in the output I (hollow line 48). The curves in dot and dash lines 49, 51 are projections of the performance of the machine 9 without the regulation device 5 according to the invention; the temperature of the alternator 9 would then be far too high (solid dot and dash line 51), with a maximum 52 at 265° C., even if the output is better (hollow dot and dash line 49).

It will be appreciated that the invention is not limited simply to the preferred embodiments described above.

In particular, the specific values of temperatures, speeds, slopes or levels specified above are given purely by way of example.

The different functional blocks of the regulation device 5, and in particular those specified of the control module 19, 20, 21 can be combined, separated or replaced by other blocks, in order to execute the same functions.

On the contrary, the invention therefore incorporates all the possible variant embodiments which would remain within the context defined by the following claims.

1. A device for regulation of an alternator of a motor vehicle, wherein the alternator subjects a direct voltage generated by the alternator to a predetermined set voltage by controlling the intensity of an excitation current which circulates in an excitation circuit comprising an excitation winding of a rotor of the alternator and also maintaining an actual temperature of the alternator below a predetermined maximum permissible temperature, the device comprising:
a control loop comprising:
means for acquisition of the direct voltage supplying a measured voltage,
a first comparator of the measured voltage of the set voltage generating a voltage error,
first means for conditioning of the voltage error providing an input excitation percentage,
a saturation module providing, according to the input excitation percentage, an output excitation percentage which is limited to a maximum permissible excitation percentage,
a generator of a pulse width modulated signal (PWM) with a duty cycle equal to the output excitation percentage,
a semiconductor switch (14) controlled by the pulse width modulated signal (PWM) controlling the intensity; and
a temperature control loop comprising:
a first means for measurement/estimation of temperature providing the actual temperature;
a second comparator generating a temperature error between the maximum permissible temperature and the actual temperature,
means for inputting an actual speed of rotation of the alternator and
a control module providing the maximum permissible excitation percentage according to the temperature error and a speed correction provided by means for correction of speed according to a predetermined correction law which depends on the actual speed of rotation.

2. The device for regulation of an alternator of a motor vehicle according to claim 1, wherein the temperature control loop further comprises a means for taking into account an ambient temperature, and wherein the correction law is parameterised by the ambient temperature.

3. The device for regulation of an alternator of a motor vehicle according to claim 2, wherein the correction law has a general dish form and comprises:
at least one first negative slope between a first speed of rotation which is variable according to the ambient temperature and a second predetermined speed of rotation,
wherein the correction law is zero between the second speed of rotation and a third predetermined speed of rotation; and
at least one second, positive slope between the third speed of rotation and a fourth speed of rotation, which varies according to the ambient temperature.

4. The device for regulation of an alternator of a motor vehicle according to claim 1, wherein the control module also comprises:
second means for conditioning of the temperature error providing a thermal correction percentage;
a comparator-adder calculating the maximum permissible excitation percentage by subtracting the thermal correction percentage from a first sum of a maximum reference excitation percentage and of the speed correction.

5. The device for regulation of an alternator of a motor vehicle according to claim 4, wherein the control module comprises means for forcing the maximum permissible excitation percentage to the maximum reference excitation percentage of 100%.

6. The device for regulation of an alternator of a motor vehicle according to claim 5, wherein the forcing means are activated by an activation order of an engine control unit of the vehicle.

7. The device for regulation of an alternator of a motor vehicle according to claim 6, wherein the forcing means are activated if, and only if, a temporal variation of the actual speed of rotation is greater as an absolute value than a predetermined threshold.

8. The device for regulation of an alternator of a motor vehicle according to claim 7, wherein the forcing means remain active for as long as the actual temperature is lower than a limit temperature equal to the maximum permissible temperature augmented by a predetermined temperature increase.

9. The device for regulation of an alternator of a motor vehicle according to the preceding claim 8, wherein characterised in that the forcing means are deactivated by a timer for a predetermined duration when the actual temperature reaches the limit temperature.

10. A motor vehicle alternator comprising a regulation device according to claim 1.
